(19) United States
(12) Patent Application Publication
(10) Pub. No.: US 2025/0238715 A1
(43) Pub. Date: Jul. 24, 2025

(54) SYSTEMS AND METHODS FOR MODEL SELECTION USING HYPERPARAMETER OPTIMIZATION COMBINED WITH FEATURE SELECTION

(71) Applicant: Capital One Services, LLC, McLean, VA (US)

(72) Inventors: Joel DANKE, McLean, VA (US); Moustafa MOHAMED, McLean, VA (US); Kamalakannan HARI KRISHNAN, McLean, VA (US); Stephen PARDY, McLean, VA (US); Jun MA, McLean, VA (US); Alexander PETERSON, McLean, VA (US)

(73) Assignee: Capital One Services, LLC, McLean, VA (US)

(21) Appl. No.: 18/421,416

(22) Filed: Jan. 24, 2024

(51) Int. Cl. G06N 20/00

(52) U.S. Cl. CPC G06N 20/00

(57) ABSTRACT

Systems and methods for selecting machine learning features using iterative batch feature reduction. In some aspects, the system receives training data intended for generating a machine learning model. Based on a preliminary model trained on the training data, the system defines a hyperparameter search space to generate a set of hyperparameter configurations. For each hyperparameter configuration, the system generates a feature vector by executing a feature selection method. Based on the set of feature vectors and the training data, the system generates a set of candidate models corresponding to the set of hyperparameter configurations. The system ranks the set of candidate models based on a performance metric to select the machine learning model from the set of candidate models.

### SUMMARY

Methods and systems are described herein for novel uses and/or improvements to artificial intelligence applications. As one example, methods and systems are described herein for performing model selection using hyperparameter optimization in conjunction with feature selection. Conventionally hyperparameter optimization is viewed as a separate problem from feature selection, and hyperparameters are often selected in an ad-hoc manner without reference to peculiarities in training data or with a feature set for training a machine learning model. An additional drawback of conventional methods for selecting machine learning model hyperparameters is that the hyperparameter choices do not interact with the feature selection process, leading to potential mismatches between ideal feature choices for a particular hyperparameter configuration.

Conventional systems have not contemplated using a preliminary model's parameter values to generate a hyperparameter search space, which may inform performing hyperparameter optimization in conjunction with feature selection. Further, doing so is technically challenging due to lack of standardized methods of using training data to inform hyperparameter search spaces and lack of a framework for performing feature selection in the context of each hyperparameter configuration.

To overcome these technical deficiencies in adapting artificial intelligence models for this practical benefit, methods and systems disclosed herein define a hyperparameter search space based on training data for generating a final machine learning model. The system may do so by training a preliminary machine learning model and using the parameter values of the preliminary model such as node-level statistics of a gradient-boosted tree to narrow down the hyperparameter search space. From the search space, the system may generate a set of hyperparameter configurations. Using a feature importance vector, the system may select a feature vector corresponding to each hyperparameter configuration. The feature vector may indicate the most relevant and impactful features from a set of features given the hyperparameter configuration. For each hyperparameter configuration, the system may train a candidate model with hyperparameter values of the configuration and using input features of the corresponding feature vector. The system may rank the candidate models by a performance metric and select the best-performing candidate models to generate the final machine learning model.

In some aspects, methods and systems are described herein comprising: receiving training data intended for generating a machine learning model, wherein the machine learning model, once generated, includes a selection from a plurality of input features based on the training data and uses a first hyperparameter configuration; based on learned parameters of a preliminary machine learning model trained using the training data, defining a hyperparameter search space, wherein the preliminary machine learning model includes an entirety of the plurality of input features, and wherein the hyperparameter search space comprises ranges for a set of hyperparameters for the machine learning model; based on a search technique, generating a set of hyperparameter configurations from the hyperparameter search space; generating, for each hyperparameter configuration in the set of hyperparameter configurations, a feature vector by executing a feature selection method, thereby generating a set of feature vectors corresponding to the set of hyperparameter configurations; based on the set of feature vectors and the training data, generating a set of candidate models corresponding to the set of hyperparameter configurations, wherein each candidate model in the set of candidate models uses a feature vector in the set of feature vectors as input features and is trained using a hyperparameter configuration corresponding to the feature vector; ranking the set of candidate models based on a performance metric; and based on the rankings of the set of candidate models, selecting the machine learning model from the set of candidate models.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for model selection using hyperparameter optimization in conjunction with feature selection, in accordance with one or more embodiments.

FIG. 2 shows an illustrative block diagram for model selection processes, including hyperparameter optimization and feature selection, in accordance with one or more embodiments.

FIG. 3 shows illustrative components for a system for model selection using hyperparameter optimization in conjunction with feature selection, in accordance with one or more embodiments.

FIG. 4 shows a flowchart of the steps involved in model selection using hyperparameter optimization in conjunction with feature selection, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

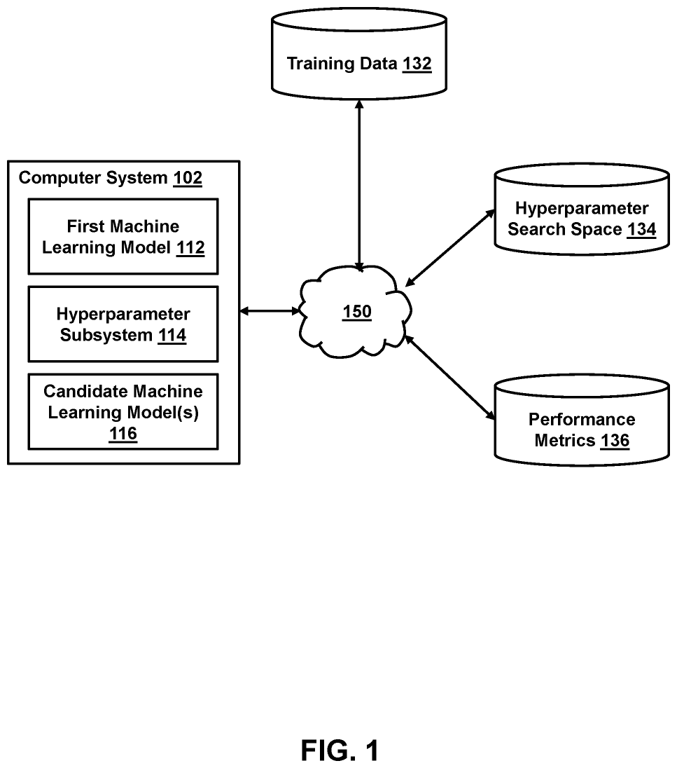

FIG. 1 shows an illustrative diagram for system 150, which contains hardware and software components used to train resource consumption machine learning models, extract explainability vectors and perform feature engineering, in accordance with one or more embodiments. For example, Computer System 102, a part of system 150, may include First Machine Learning Model 112, Hyperparameter Subsystem 114, and Candidate Machine Learning Model(s) 116.

System 150 may receive Training Data 132. Training Data 132 may contain a first set of features, which may be used as input by a machine learning model (e.g., First Machine Learning Model 112). Training Data 132 may, for example, include a plurality of user profiles relating to resource consumption for a plurality of user systems. The first set of features may contain categorical or quantitative variables, and values for such features may describe, for example, a length of time for which the user system has recorded resource consumption, an extent and frequency of resource consumption, and the number of instances of the user system's excessive resource consumption. Each user profile may correspond to a resource consumption value indicating the current consumption of resources by the user system, which may also be recorded in Training Data 132 in association with the user profile. The system may retrieve a plurality of user profiles as a matrix including vectors of feature values for the first set of features and append to the end of each vector a resource consumption value.

In some embodiments, the system may, before retrieving user profiles, process Training Data 132 using a data cleansing process to generate a processed dataset. The data cleansing process may include removing outliers, standardizing data types, formatting and units of measurement, and removing duplicate data. The system may then retrieve vectors corresponding to user profiles from the processed dataset.

Training Data 132 may be intended for training a lean machine learning model, which uses an algorithm to translate a set of input features into an output. The lean machine learning model, in addition to choices regarding input features, requires a hyperparameter configuration. A hyperparameter governs an aspect of the learning process for a machine learning model. A hyperparameter configuration includes choices for which hyperparameter types are needed, and values for each hyperparameter that define and limit a machine learning model. For example, a hyperparameter may be the learning rate for training a neural network, the train-test split ratio for a training dataset, the batch size or the number of epochs for batch training, the branches in a decision tree, the number of clusters in a clustering algorithm, the topology and size of a neural network, the number of nodes and layers in a neural network, or a regularization rate, among other possible hyperparameters. For example, hyperparameters for a gradient-boosted tree ensemble algorithm may include a maximum tree depth, a minimum child weight, a maximum tree breadth, an average bias of residuals at a node, and an amount of improvement in a loss function. Hyperparameters often govern the basic structure of a machine learning model and/or choices for how parameter values are generated. By contrast, parameter values constitute instances of algorithms translating an input value into an output value. For example, for a neural network, the layers of neurons, the activation functions for neurons, and the backpropagation rate are hyperparameters.

Based on Training Data 132, the system may define a hyperparameter search space. The hyperparameter search space describes possible values of hyperparameters. For example, hyperparameters may be real values, and thus a hyperparameter search space may be a multi-dimensional real-valued space encompassing possible ranges of values for each hyperparameter. A hyperparameter configuration is a set of real values specifying a set of hyperparameter values, using which the system can train a machine learning model. In some embodiments, the hyperparameter configuration is independent of the features used in the machine learning model. For example, the choice for what input features a neural network will use is independent from the choice of how many deep learning layers the neural network will use to transform its inputs into output values. In some embodiments, the system may define the hyperparameter search space using a predetermined computation process on Training Data 132. For example, the system may define the hyperparameter search space in terms of testing requirement and training batch division hyperparameters, and may select values for the hyperparameters based on intrinsic properties of Training Data 132. For example, the system may set the search space for the hyperparameter of training batch size to be between one percent of the entries of Training Data 132 and ten percent of the entries of Training Data 132. This results in a range of possibilities for training batch size, and differing hyperparameter values (batch sizes) result in differing training schemes that produce candidate machine learning models (e.g., among those of Candidate Machine Learning Model(s) 116) with differing performance scores. In some embodiments, instead of using intrinsic properties of Training Data 132 to define the hyperparameter search space, the system may train a preliminary Machine Learning Model (e.g., First Machine Learning Model 112) and use the preliminary model to define value ranges for one or more hyperparameters of the hyperparameter search space. The preliminary model may use a set of features too cumbersome for deployment to actual scenarios. The set of features may lead to unnecessary complexity and overfitting of the preliminary model, and are thus considered non-final. The input features to the preliminary model may only serve to allow exploration of a hyperparameter search space for the purpose of generating a final machine learning model.

The system may train a preliminary machine learning model (e.g., First Machine Learning Model 112) based on a matrix representing the plurality of user profiles. First Machine Learning Model 112 may take as input a vector of feature values for the entirety of first set of features and output a resource consumption score indicating an amount of resources used by a user system with such feature values as the input. First Machine Learning Model 112 may use one or more algorithms like linear regression, generalized additive models, artificial neural networks or random forests to achieve quantitative prediction. The system may partition the matrix of user profiles into a training set and a cross-validating set. Using the training set, the system may train First Machine Learning Model 112 using, for example, the gradient descent technique. The system may then cross-validate the trained model using the cross-validating set and further fine-tune the parameters of the model. First Machine Learning Model 112 may include one or more parameters that it uses to translate input into outputs. For example, an artificial neural network contains a matrix of weights, each weight in which is a real number. The repeated multiplication and combination of weights transform input values to First Machine Learning Model 112 into output values. The system may measure the performance of First Machine Learning Model 112 using a method such as cross-validation to generate a quantitative representation, e.g., a first performance metric.

The features used by First Machine Learning Model 112 may be indicative of a full set of features under consideration, instead of a desirable set of features for a lean and high-performing model. The system may wish to select features from among the ones used by First Machine Learning Model 112 to generate a final model, and First Machine Learning Model 112 may only serve to illuminate value ranges for hyperparameters which inform the hyperparameter search space (e.g., Hyperparameter Search Space 134). For algorithms like gradient-boosted tree ensembles, hyperparameters such as gamma, minimum child weight, maximum delta step, regularization alpha, and regularization lambda may be informed by First Machine Learning Model 112. For example, the system may use the trained parameter values of First Machine Learning Model 112 as basepoints around which to generate ranges for the hyperparameter values. The system may use learned parameters, such as node-level statistics, to serve as baselines in the search space of data-dependent hyperparameters. If First Machine Learning Model 112 was trained by dividing Training Data 132 into batches of data each containing 1000 entries, then the system may use 1000 as a baseline for the hyperparameter value of batch size. The system may generate the search space for batch size by scaling the baseline value to determine an upper bound and a lower bound for the search space. For example, the system may scale the baseline hyperparameter value down by 1000 and up by 1000 respectively to generate a lower bound batch size of 1 and an upper bound batch size of 1000000. Hyperparameter Search Space 134 for batch size is thus defined for integers between 1 and 1000000. Similar processes for other hyperparameters allow the system to generate search spaces for each hyperparameter based on hyperparameter values used in training First Machine Learning Model 112. For example, First Machine Learning Model 112 may use a gradient-boosted tree ensemble algorithm, and the system may use hyperparameter values used in training First Machine Learning Model 112 regarding the number of trees in the ensemble, the maximum depth of the trees, or the learning rate. Hyperparameter search spaces for each hyperparameter may be generated by scaling or varying the values used by First Machine Learning Model 112 for each hyperparameter.

The system may use a search technique on Hyperparameter Search Space 134 to generate a set of hyperparameter configurations (e.g., using Hyperparameter Subsystem 114). Each hyperparameter configuration is a set of values for each hyperparameter required for training a model and one or more optional hyperparameters, where applicable. The system may generate the set of hyperparameter configurations by performing a search technique on Hyperparameter Search Space 134, such as a Latin Hypercube sampling algorithm. The system may use search techniques that randomly generate values from Hyperparameter Search Space 134 such as random sampling. Additionally or alternatively, the system may generate hyperparameter configurations by taking sets of values equally spaced in Hyperparameter Search Space 134. The system may, for example, iteratively add a real value to a starting point to obtain a set of values for a hyperparameter. The system may do the same for each other hyperparameter to generate hyperparameter configurations. Similarly, the system may generate starting values for each of the hyperparameters and randomly permute the values to result in sets of values for each hyperparameter.

Hyperparameter Subsystem 114 may generate, for each hyperparameter configuration in the set of hyperparameter configurations, a feature vector by executing a feature selection method. For example, the system may train a prototype machine learning model using the hyperparameter configuration (e.g., First Machine Learning Model 112). Hyperparameter Subsystem 114 may initialize a standard feature set for First Machine Learning Model 112, the standard feature set capturing for example a complete set of possible features. First Machine Learning Model 112 may be re-trained using hyperparameter values for each configuration in the set of hyperparameter configurations. In some embodiments, the standard set of features may be so numerous or cumbersome that the system may choose to select a subset of the most relevant features from the complete set of features. To do so, the system may process the prototype machine learning model to extract a feature importance vector specifying the importance of each feature in generating outputs of the prototype machine learning model. Below are some examples of how the system extracts the feature importance vector from First Machine Learning Model 112 for a hyperparameter configuration, a process which may be repeated for each hyperparameter configuration.

For example, First Machine Learning Model 112 may contain a matrix of weights for a multivariate regression algorithm. The system may use a Shapley Additive Explanation method to extract the feature importance vector. Shapley Additive Explanation computes Shapley values in coalitional game theory, treating each feature in the input features of a model as participants in a coalition. Each feature therefore gets assigned a Shapley value capturing their contribution to producing the prediction of the model. The magnitude of Shapley values of each feature is then normalized. The feature importance vector may be a list of normalized Shapley values of each feature.

In another example, First Machine Learning Model 112 may contain a vector(s) of coefficients for a generalized additive model. Since the nature of generalized additive models is such that the effect of each variable on the output is completely and independently captured by its coefficient, The system may take the list of coefficients to be the feature importance vector.

In another example, First Machine Learning Model 112 may contain a matrix of weights for a supervised classifier algorithm. The system may use a Local Interpretable Model-agnostic Explanations method to extract the feature importance vector. The Local Interpretable Model-agnostic Explanations approximates the results of First Machine Learning Model 112 with an explainable model, e.g., a decision tree classifier. The approximate model is trained using a loss heuristic that judges similarity to First Machine Learning Model 112 and that penalizes complexity. In some embodiments, the number of variables that the approximate model uses can be specified. The approximate model will clearly define the effect of each feature on the output: for example, the approximate model may be a generalized additive model.

In another example, First Machine Learning Model 112 may contain a matrix of weights for a convolutional neural network algorithm. The system may use a Gradient Class Activation Mapping method to extract the feature importance vector. The Grad-CAM technique performs backpropagation on the output of the model with respect to the final convolutional feature map to compute derivatives of features in the input with respect to the output of the model. The derivatives may then be used as indications of importance of features to a model, and the feature importance vector may be a list of such derivatives.

In another example, First Machine Learning Model 112 may contain a set of parameters comprising a hyperplane matrix for a support vector(s) machine algorithm. The system may use a counterfactual explanation method to extract the feature importance vector. The counterfactual explanation method looks for input data which are identical or extremely close in values for all features except one. Then the difference in prediction results may divided by the difference in the divergent value. This process is repeated on each feature for all pairs of available input vector(s) s, and the aggregated result is a measure for the effect of each feature on the output of the model, which may be formed into the feature importance vector.

For each hyperparameter configuration, using the feature importance vector of the corresponding prototype machine learning model, the system may select a subset of features from the full set of features. In some embodiments, the subset of features may be features satisfying a percentile cutoff based on their values in the feature importance vector for the candidate model. For example, the system may select the top ninety percent of features as ranked by values in the feature importance vector. In some embodiments, the system may choose a subset of features by removing a fixed number of lowest-ranking features by values in the feature importance vector. For example, the system may remove the bottom 50 features ranked by values in the feature importance vector from the feature group to form the subset of features on the remaining features. In some embodiments, the system may calculate a threshold value for removing features. All features with values in the feature importance vector below the threshold value may be removed, and remaining features may form the subset of features. Thus, each hyperparameter configuration may correspond to a feature vector containing the subset of features selected based on the prototype machine learning model using the hyperparameter configuration.

The system may generate a set of candidate models (e.g., Candidate Machine Learning Model(s) 116), each candidate model in which corresponds to a hyperparameter configuration and its feature vector. A candidate model in Candidate Machine Learning Model(s) 116 uses the feature vector as its input features and takes on the values of the hyperparameter configuration for its hyperparameter choices. The system may train each candidate model in Candidate Machine Learning Model(s) 116 using Training Data 132, to ensure that differences between the performance of candidate models are due to hyperparameter values and feature choices. In some embodiments, the system may perform a random permutation on the feature vector of a candidate model, and use the permuted feature vector as input features. The system may partition Training Data 132 into a training set and a testing set. Using the training set, the system may generate parameter values for each candidate model in Candidate Machine Learning Model(s) 116, with each model using a distinct hyperparameter configuration and input feature vector. Each candidate model in Candidate Machine Learning Model(s) 116 may use the same algorithm, which may be the algorithm of First Machine Learning Model 112. Hyperparameter values may differ between candidate models, however. For example, all candidate models may use the boosted gradient ensemble algorithm trained using stochastic gradient descent, but tree depth and the maximum number of nodes for each tree may differ between candidate models. In addition, the training set may be divided into training epochs of different sizes for candidate models. After training is complete for each candidate model, a performance metric may be generated for the candidate model. This set of performance metrics (e.g., Performance Metrics 136) may be the result of testing the candidate model on the testing set, and may be reflective of a similarity of output by the candidate model and standard outputs in the testing set. For example, the performance metric may be a classification error rate of the candidate model.

The system ranks Candidate Machine Learning Model(s) 116 based on Performance Metrics 136 and selects a final machine learning model. In some embodiments, the system may select the candidate model with the best performance metric to be the final machine learning model. For example, the candidate model with the lowest error rate may be the final machine learning model. The final machine learning model uses a lightweight set of features when compared to First Machine Learning Model 112, and may perform better along a number of dimensions due to optimized hyperparameter choices and feature selection. In some other embodiments, the system may use a feature allocation map to determine features for the final machine learning model. For the set of features used in the final machine learning model, the system may select a portion of the set of features from each candidate model based on the performance metric. For example, the feature allocation map may specify that half the set of features is derived from the top-ranking candidate model, a quarter of the set of features is from the second top-ranking candidate model, and the last quarter of features from the third top-ranking candidate model. The system may extract the corresponding features from each of the candidate models, selecting the features with highest values in the feature importance vectors in each respective candidate model. The final machine learning model uses the resultant set of features.

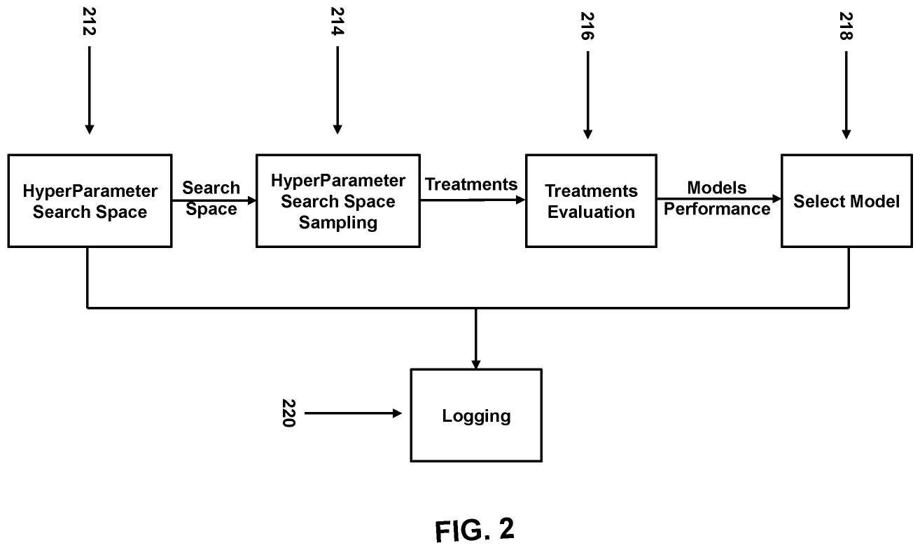

FIG. 2 shows a process of determining hyperparameter configurations and feature selections for a final machine learning model. For example, the system may generate a Hyperparameter Search Space 212 (equivalent to Hyperparameter Search Space 134 described above) based on training data received for generating a final machine learning model. For example, the system may use a preliminary model's values for hyperparameters as reference points for Hyperparameter Search Space 212.

From Hyperparameter Search Space 212, the system may generate Sampling 214. Sampling 214 may be a random sample consisting of a value for each hyperparameter in the set of hyperparameters. For example, the system may use a probabilistic sampling method to find real values in Hyperparameter Search Space 212 for each hyperparameter and produce Sampling 214, which may be a collection of hyperparameter configurations.

For each hyperparameter configuration in Sampling 214, the system may generate a corresponding feature vector in Treatments 216. The system may do so by first training a preliminary model using the hyperparameter configuration. The preliminary model may use a full set of features and hyperparameter values of the hyperparameter configuration. The system may extract a feature importance vector from this preliminary model. Using the feature importance vector, the system may select a subset of features with the highest values in the feature importance vector, indicating a high impact for the preliminary model.

Now that the system has collected feature vectors in Treatments 216 corresponding to hyperparameter configurations, the system may train a set of candidate models. Each candidate model uses a hyperparameter configuration as its hyperparameter values, and takes as input the feature vector corresponding to the hyperparameter configuration. Unlike a preliminary model, whose input feature set was designed to be comprehensive instead of efficient, the candidate model is intended to perform well using its input features and hyperparameter values. Thus, the system may collect a set of performance metrics, consisting of one or more real numbers for each candidate model. The performance metric for each candidate model may be, for example, an error rate based on testing data.

The system may rank the candidate models based on their respective values in the performance metric, and select a model, for example Final Machine Learning Model 218, from the set of candidate models. In some embodiments, Final Machine Learning Model 218 may use the hyperparameter configuration and features of the single highest-performing model. In some embodiments, Final Machine Learning Model 218 may use hyperparameter configurations and features based on a weighted combination of a plurality of candidate models based on their performance.

The system may record one or more aspects of the above process using a logging format. For example, the system may document in Log 220 data such as the preliminary model used to inform Hyperparameter Search Space 212, the ranges of hyperparameter values in Hyperparameter Search Space 212, the hyperparameter configurations in Sampling 214, the feature vectors corresponding to each hyperparameter configuration in Treatments 216, each candidate model in the set of candidate models, and their respective performance metric scores. The system may use Log 220 for the benefit of generating a different final machine learning model. For example, when generating a machine learning model performing an adjacent or similar task, the system may retrieve Log 220 and use Hyperparameter Search Space 212 to generate hyperparameter configurations. Additionally, Log 220 provides accountability to the training, feature selection and hyperparameter optimization process, aiding the standardization of choices regarding hyperparameter configurations and features used in final machine learning models.

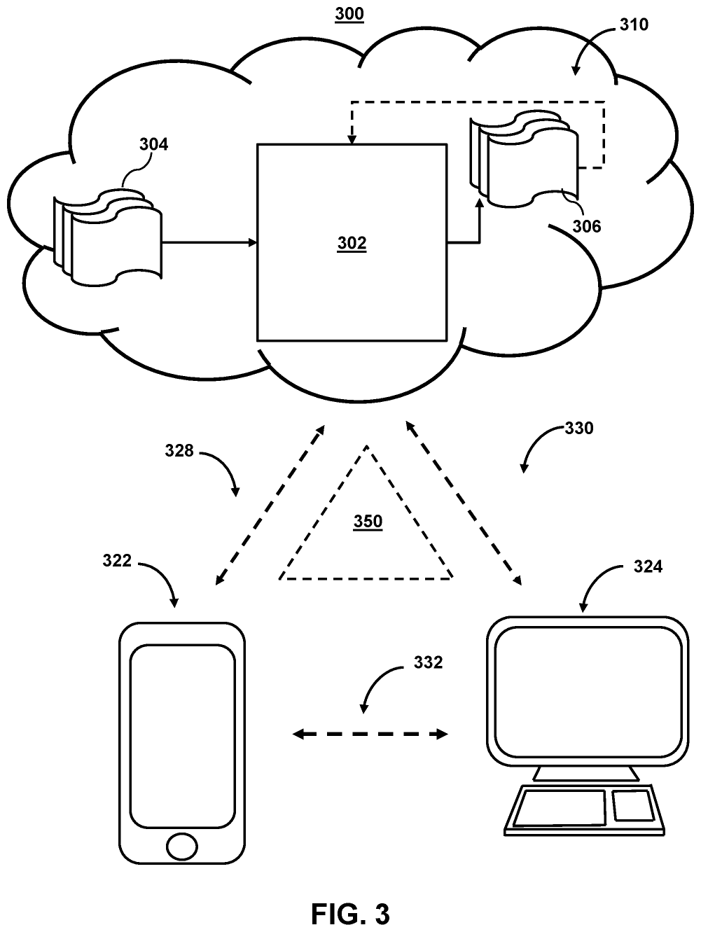

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., predicting resource allocation values for user systems).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., predicting resource allocation values for user systems).

In some embodiments, the model (e.g., model 302) may automatically perform actions based on outputs 306. In some embodiments, the model (e.g., model 302) may not perform any actions. The output of the model (e.g., model 302) may be used to predict predicting resource allocation values for user systems).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDOS protection, and API layer 350 may use RESTful APIs as standard for external integration.

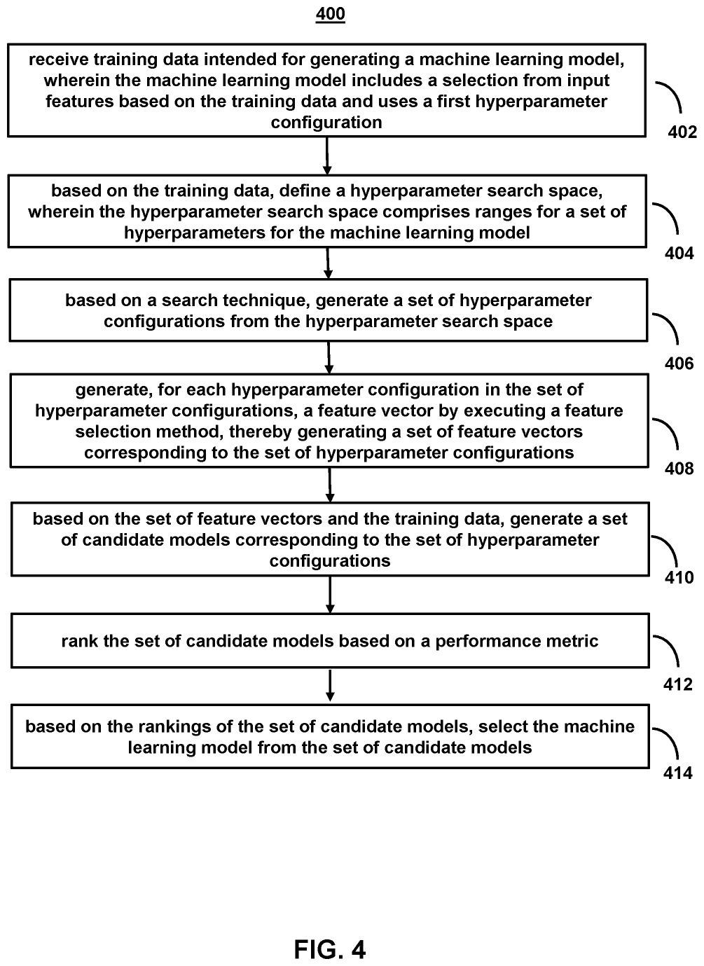

FIG. 4 shows a flowchart of the steps involved in model selection using hyperparameter optimization in conjunction with feature selection, in accordance with one or more embodiments. For example, the system may use process 400 (e.g., as implemented on one or more system components described above) in order to define a hyperparameter search space based on training data, generate hyperparameter configurations based on the search space, identify feature vectors for each hyperparameter configuration, train candidate models and use candidate models to generate a finalized machine learning model.

At step 402, process 400 (e.g., using one or more components described above) may receive training data intended for generating a machine learning model, wherein the machine learning model includes a selection from input features based on the training data and uses a first hyperparameter configuration. The system may receive Training Data 132. Training Data 132 may contain a first set of features, which may be used as input by a machine learning model (e.g., First Machine Learning Model 112). Training Data 132 may, for example, include a plurality of user profiles relating to resource consumption for a plurality of user systems. The first set of features may contain categorical or quantitative variables, and values for such features may describe, for example, a length of time for which the user system has recorded resource consumption, an extent and frequency of resource consumption, and the number of instances of the user system's excessive resource consumption. Each user profile may correspond to a resource consumption value indicating the current consumption of resources by the user system, which may also be recorded in Training Data 132 in association with the user profile. The system may retrieve a plurality of user profiles as a matrix including vectors of feature values for the first set of features and append to the end of each vector a resource consumption value.

In some embodiments, the system may, before retrieving user profiles, process Training Data 132 using a data cleansing process to generate a processed dataset. The data cleansing process may include removing outliers, standardizing data types, formatting and units of measurement, and removing duplicate data. The system may then retrieve vectors corresponding to user profiles from the processed dataset.

Training Data 132 may be intended for training a lean machine learning model, which uses an algorithm to translate a set of input features into an output. The lean machine learning model, in addition to choices regarding input features, requires a hyperparameter configuration. A hyperparameter governs an aspect of the learning process for a machine learning model. A hyperparameter configuration includes choices for which hyperparameter types are needed, and values for each hyperparameter that define and limit a machine learning model. For example, a hyperparameter may be the learning rate for training a neural network, the train-test split ratio for a training dataset, the batch size or the number of epochs for batch training, the branches in a decision tree, the number of clusters in a clustering algorithm, the topology and size of a neural network, the number of nodes and layers in a neural network, or a regularization rate, among other possible hyperparameters. For example, hyperparameters for a gradient-boosted tree ensemble algorithm may include a maximum tree depth, a minimum child weight, a maximum tree breadth, an average bias of residuals at a node, and an amount of improvement in a loss function. Hyperparameters often govern the basic structure of a machine learning model and/or choices for how parameter values are generated. By contrast, parameter values constitute instances of algorithms translating an input value into an output value. For example, for a neural network, the layers of neurons, the activation functions for neurons, and the backpropagation rate are hyperparameters.

At step 404, process 400 (e.g., using one or more components described above) may, based on the training data, define a hyperparameter search space, wherein the hyperparameter search space comprises ranges for a set of hyperparameters for the machine learning model. Based on Training Data 132, the system may define a hyperparameter search space. The hyperparameter search space describes possible values of hyperparameters. For example, hyperparameters may be real values, and thus a hyperparameter search space may be a multi-dimensional real-valued space encompassing possible ranges of values for each hyperparameter. A hyperparameter configuration is a set of real values specifying a set of hyperparameter values, using which the system can train a machine learning model. In some embodiments, the hyperparameter configuration is independent of the features used in the machine learning model. For example, the choice for what input features a neural network will use is independent from the choice of how many deep learning layers the neural network will use to transform its inputs into output values. In some embodiments, the system may define the hyperparameter search space using a predetermined computation process on Training Data 132. For example, the system may define the hyperparameter search space in terms of testing requirement and training batch division hyperparameters, and may select values for the hyperparameters based on intrinsic properties of Training Data 132. For example, the system may set the search space for the hyperparameter of training batch size to be between one percent of the entries of Training Data 132 and ten percent of the entries of Training Data 132. This results in a range of possibilities for training batch size, and differing hyperparameter values (batch sizes) result in differing training schemes that produce candidate machine learning models (e.g., among those of Candidate Machine Learning Model(s) 116) with differing performance scores. In some embodiments, instead of using intrinsic properties of Training Data 132 to define the hyperparameter search space, the system may train a preliminary Machine Learning Model (e.g., First Machine Learning Model 112) and use the preliminary model to define value ranges for one or more hyperparameters of the hyperparameter search space. The preliminary model may use a set of features too cumbersome for deployment to actual scenarios. The set of features may lead to unnecessary complexity and overfitting of the preliminary model, and are thus considered non-final. The input features to the preliminary model may only serve to allow exploration of a hyperparameter search space for the purpose of generating a final machine learning model.

The system may train a preliminary machine learning model (e.g., First Machine Learning Model 112) based on a matrix representing the plurality of user profiles. The system may use the learned parameters of the preliminary machine learning model, such as node-level statistics of a gradient-boosting tree algorithm, to generate the hyperparameter search space. First Machine Learning Model 112 may take as input a vector of feature values for the entirety of first set of features and output a resource consumption score indicating an amount of resources used by a user system with such feature values as the input. First Machine Learning Model 112 may use one or more algorithms like linear regression, generalized additive models, artificial neural networks or random forests to achieve quantitative prediction. The system may partition the matrix of user profiles into a training set and a cross-validating set. Using the training set, the system may train First Machine Learning Model 112 using, for example, the gradient descent technique. The system may then cross-validate the trained model using the cross-validating set and further fine-tune the parameters of the model. First Machine Learning Model 112 may include one or more parameters that it uses to translate input into outputs. For example, an artificial neural network contains a matrix of weights, each weight in which is a real number. The repeated multiplication and combination of weights transform input values to First Machine Learning Model 112 into output values. The system may measure the performance of First Machine Learning Model 112 using a method such as cross-validation to generate a quantitative representation, e.g., a first performance metric.

The features used by First Machine Learning Model 112 may be indicative of a full set of features under consideration, instead of a desirable set of features for a lean and high-performing model. The system may wish to select features from among the ones used by First Machine Learning Model 112 to generate a final model, and First Machine Learning Model 112 may only serve to illuminate value ranges for hyperparameters which inform the hyperparameter search space (e.g., Hyperparameter Search Space 134). For example, the system may use the hyperparameter values used in training First Machine Learning Model 112 as basepoints around which to generate ranges for the hyperparameter values. If First Machine Learning Model 112 was trained by dividing Training Data 132 into batches of data each containing 1000 entries, then the system may use 1000 as a baseline for the hyperparameter value of batch size. The system may generate the search space for batch size by scaling the baseline value to determine an upper bound and a lower bound for the search space. For example, the system may scale the baseline hyperparameter value down by 1000 and up by 1000 respectively to generate a lower bound batch size of 1 and an upper bound batch size of 1000000. Hyperparameter Search Space 134 for batch size is thus defined for integers between 1 and 1000000. Similar processes for other hyperparameters allow the system to generate search spaces for each hyperparameter based on hyperparameter values used in training First Machine Learning Model 112. For example, First Machine Learning Model 112 may use a gradient-boosted tree ensemble algorithm, and the system may use hyperparameter values used in training First Machine Learning Model 112 regarding the number of trees in the ensemble, the maximum depth of the trees, or the learning rate. Hyperparameter search spaces for each hyperparameter may be generated by scaling or varying the values used by First Machine Learning Model 112 for each hyperparameter.

At step 406, process 400 (e.g., using one or more components described above) may, based on a search technique, generate a set of hyperparameter configurations from the hyperparameter search space. The system may use a search technique on Hyperparameter Search Space 134 to generate a set of hyperparameter configurations (e.g., using Hyperparameter Subsystem 114). Each hyperparameter configuration is a set of values for each hyperparameter required for training a model and one or more optional hyperparameters, where applicable. The system may generate the set of hyperparameter configurations by performing a search technique on Hyperparameter Search Space 134, such as a Latin Hypercube sampling algorithm. The system may use search techniques that randomly generate values from Hyperparameter Search Space 134 such as random sampling. Additionally or alternatively, the system may generate hyperparameter configurations by taking sets of values equally spaced in Hyperparameter Search Space 134. The system may, for example, iteratively add a real value to a starting point to obtain a set of values for a hyperparameter. The system may do the same for each other hyperparameter to generate hyperparameter configurations. Similarly, the system may generate starting values for each of the hyperparameters and randomly permute the values to result in sets of values for each hyperparameter.

At step 408, process 400 (e.g., using one or more components described above) may generate, for each hyperparameter configuration in the set of hyperparameter configurations, a feature vector by executing a feature selection method, thereby generating a set of feature vectors corresponding to the set of hyperparameter configurations. Hyperparameter Subsystem 114 may generate, for each hyperparameter configuration in the set of hyperparameter configurations, a feature vector by executing a feature selection method. For example, the system may train a prototype machine learning model using the hyperparameter configuration (e.g., First Machine Learning Model 112). Hyperparameter Subsystem 114 may initialize a standard feature set for First Machine Learning Model 112, the standard feature set capturing for example a complete set of possible features. In some embodiments, the standard set of features may be so numerous or cumbersome that the system may choose to select a subset of the most relevant features from the complete set of features. To do so, the system may process the prototype machine learning model to extract a feature importance vector specifying the importance of each feature in generating outputs of the prototype machine learning model. Below are some examples of how the system extracts the feature importance vector from First Machine Learning Model 112.

For example, First Machine Learning Model 112 may contain a matrix of weights for a multivariate regression algorithm. The system may use a Shapley Additive Explanation method to extract the feature importance vector. Shapley Additive Explanation computes Shapley values in coalitional game theory, treating each feature in the input features of a model as participants in a coalition. Each feature therefore gets assigned a Shapley value capturing their contribution to producing the prediction of the model. The magnitude of Shapley values of each feature is then normalized. The feature importance vector may be a list of normalized Shapley values of each feature.

In another example, First Machine Learning Model 112 may contain a vector(s) of coefficients for a generalized additive model. Since the nature of generalized additive models is such that the effect of each variable on the output is completely and independently captured by its coefficient, The system may take the list of coefficients to be the feature importance vector.

In another example, First Machine Learning Model 112 may contain a matrix of weights for a supervised classifier algorithm. The system may use a Local Interpretable Model-agnostic Explanations method to extract the feature importance vector. The Local Interpretable Model-agnostic Explanations approximates the results of First Machine Learning Model 112 with an explainable model, e.g., a decision tree classifier. The approximate model is trained using a loss heuristic that judges similarity to First Machine Learning Model 112 and that penalizes complexity. In some embodiments, the number of variables that the approximate model uses can be specified. The approximate model will clearly define the effect of each feature on the output: for example, the approximate model may be a generalized additive model.

In another example, First Machine Learning Model 112 may contain a matrix of weights for a convolutional neural network algorithm. The system may use a Gradient Class Activation Mapping method to extract the feature importance vector. The Grad-CAM technique performs backpropagation on the output of the model with respect to the final convolutional feature map to compute derivatives of features in the input with respect to the output of the model. The derivatives may then be used as indications of importance of features to a model, and the feature importance vector may be a list of such derivatives.

In another example, First Machine Learning Model 112 may contain a set of parameters comprising a hyperplane matrix for a support vector(s) machine algorithm. The system may use a counterfactual explanation method to extract the feature importance vector. The counterfactual explanation method looks for input data which are identical or extremely close in values for all features except one. Then the difference in prediction results may divided by the difference in the divergent value. This process is repeated on each feature for all pairs of available input vector(s) s, and the aggregated result is a measure for the effect of each feature on the output of the model, which may be formed into the feature importance vector.

For each hyperparameter configuration, using the feature importance vector of the corresponding prototype machine learning model, the system may select a subset of features from the full set of features. In some embodiments, the subset of features may be features satisfying a percentile cutoff based on their values in the feature importance vector for the candidate model. For example, the system may select the top ninety percent of features as ranked by values in the feature importance vector. In some embodiments, the system may choose a subset of features by removing a fixed number of lowest-ranking features by values in the feature importance vector. For example, the system may remove the bottom 50 features ranked by values in the feature importance vector from the feature group to form the subset of features on the remaining features. In some embodiments, the system may calculate a threshold value for removing features. All features with values in the feature importance vector below the threshold value may be removed, and remaining features may form the subset of features. Thus, each hyperparameter configuration may correspond to a feature vector containing the subset of features selected based on the prototype machine learning model using the hyperparameter configuration.

At step 410, process 400 (e.g., using one or more components described above) may, based on the set of feature vectors and the training data, generate a set of candidate models corresponding to the set of hyperparameter configurations. The system may generate a set of candidate models (e.g., Candidate Machine Learning Model(s) 116), each candidate model in which corresponds to a hyperparameter configuration and its feature vector. A candidate model in Candidate Machine Learning Model(s) 116 uses the feature vector as its input features and takes on the values of the hyperparameter configuration for its hyperparameter choices. The system may train each candidate model in Candidate Machine Learning Model(s) 116 using Training Data 132, to ensure that differences between the performance of candidate models are due to hyperparameter values and feature choices. In some embodiments, the system may perform a random permutation on the feature vector of a candidate model, and use the permuted feature vector as input features. The system may partition Training Data 132 into a training set and a testing set. Using the training set, the system may generate parameter values for each candidate model in Candidate Machine Learning Model(s) 116, with each model using a distinct hyperparameter configuration and input feature vector. Each candidate model in Candidate Machine Learning Model(s) 116 may use the same algorithm, which may be the algorithm of First Machine Learning Model 112. Hyperparameter values may differ between candidate models, however. For example, all candidate models may use the boosted gradient ensemble algorithm trained using stochastic gradient descent, but tree depth and the maximum number of nodes for each tree may differ between candidate models. In addition, the training set may be divided into training epochs of different sizes for candidate models. After training is complete for each candidate model, a performance metric may be generated for the candidate model. This set of performance metrics (e.g., Performance Metrics 136) may be the result of testing the candidate model on the testing set, and may be reflective of a similarity of output by the candidate model and standard outputs in the testing set. For example, the performance metric may be a classification error rate of the candidate model.

At step 412, process 400 (e.g., using one or more components described above) may rank the set of candidate models based on a performance metric. The system ranks Candidate Machine Learning Model(s) 116 based on Performance Metrics 136 and selects a final machine learning model. In some embodiments, the system may select the candidate model with the best performance metric to be the final machine learning model. For example, the candidate model with the lowest error rate may be the final machine learning model. The final machine learning model uses a lightweight set of features when compared to First Machine Learning Model 112, and may perform better along a number of dimensions due to optimized hyperparameter choices and feature selection.

At step 414, process 400 (e.g., using one or more components described above) may, based on the rankings of the set of candidate models, select the machine learning model from the set of candidate models. In some embodiments, the system may use a feature allocation map to determine features for the final machine learning model. For the set of features used in the final machine learning model, the system may select a portion of the set of features from each candidate model based on the performance metric. For example, the feature allocation map may specify that half the set of features is derived from the top-ranking candidate model, a quarter of the set of features is from the second top-ranking candidate model, and the last quarter of features from the third top-ranking candidate model. The system may extract the corresponding features from each of the candidate models, selecting the features with highest values in the feature importance vectors in each respective candidate model. The final machine learning model uses the resultant set of features.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: receiving training data intended for generating an final machine learning model, wherein the final machine learning model, once generated, includes a selection from a plurality of input features based on the training data and uses a first hyperparameter configuration; training a preliminary machine learning model using the training data to generate learned parameter values of the preliminary machine learning model, wherein the preliminary machine learning model includes an entirety of the plurality of input features, and wherein the learned parameter values comprise feature values and node-level statistics of a gradient-boosted algorithm; based on the learned parameter values of the preliminary machine learning model, defining a hyperparameter search space, wherein the hyperparameter search space comprises ranges for a set of hyperparameters for the final machine learning model; generating a set of hyperparameter configurations from the hyperparameter search space; generating, for each hyperparameter configuration in the set of hyperparameter configurations, a feature vector by executing a feature selection method, thereby generating a set of feature vectors corresponding to the set of hyperparameter configurations; based on the set of feature vectors and the training data, generating a set of candidate models corresponding to the set of hyperparameter configurations, wherein each candidate model in the set of candidate models uses a feature vector in the set of feature vectors as input features and is trained using a hyperparameter configuration corresponding to the feature vector; ranking the set of candidate models based on a performance metric; and based on the rankings of the set of candidate models, selecting the simple machine learning model from the set of candidate models.
2. A method comprising: receiving training data intended for generating a machine learning model, wherein the machine learning model, once generated, includes a selection from a plurality of input features based on the training data and uses a first hyperparameter configuration; based on learned parameter values of a preliminary machine learning model trained using the training data, defining a hyperparameter search space, wherein the preliminary machine learning model includes an entirety of the plurality of input features, and wherein the hyperparameter search space comprises ranges for a set of hyperparameters for the machine learning model; based on a search technique, generating a set of hyperparameter configurations from the hyperparameter search space; generating, for each hyperparameter configuration in the set of hyperparameter configurations, a feature vector by executing a feature selection method, thereby generating a set of feature vectors corresponding to the set of hyperparameter configurations; based on the set of feature vectors and the training data, generating a set of candidate models corresponding to the set of hyperparameter configurations, wherein each candidate model in the set of candidate models uses a feature vector in the set of feature vectors as input features and is trained using a hyperparameter configuration corresponding to the feature vector; ranking the set of candidate models based on a performance metric; and based on the rankings of the set of candidate models, selecting the machine learning model from the set of candidate models.
3. The method of any one of the preceding embodiments, wherein the search technique for generating the set of hyperparameter configurations is a Latin Hypercube sampling algorithm.
4. The method of any one of the preceding embodiments, wherein the machine learning model uses a boosted gradient ensemble algorithm.
5. The method of any one of the preceding embodiments, wherein the feature selection method for a hyperparameter configuration comprises: initializing a standard feature set to train a prototype machine learning model with, wherein the prototype machine learning model uses an algorithm as the machine learning model and is trained on the training data, and wherein the prototype machine learning model uses the hyperparameter configuration for its hyperparameter values; processing the prototype machine learning model to extract a feature importance vector, wherein the feature importance vector specifies an importance of each feature in the standard feature set in generating outputs of the prototype machine learning model; and eliminating a set number of features from the standard feature set based on the feature importance vector.
6. The method of any one of the preceding embodiments, wherein generating a candidate model in the set of candidate models from a feature vector in the set of feature vectors comprises: performing a random permutation on the feature vector to generate a training feature set; and training the candidate model using the training data, wherein the candidate model uses the training feature set as input features.
7. The method of any one of the preceding embodiments, wherein ranking the set of candidate models based on the performance metric comprises: partitioning the training data into a sample set and a testing set; training each candidate model in the set of candidate models on the sample set; for each candidate model in the set of candidate models, performing cross-validation testing of the candidate model using the testing set to obtain a performance metric; and ranking the set of candidate models based on respective performance metrics.
8. The method of any one of the preceding embodiments, wherein generating the machine learning model using the rankings of the set of candidate models comprises: based on the rankings of the set of candidate models, generating a feature allocation map, wherein the feature allocation map correlates each candidate model in the set of candidate models with an integer number of features; for each candidate model in the set of candidate models, use a feature ranking technique to extract a number of features equal to that specified by the feature allocation map; and generating the machine learning model to use the extracted features as input.
9. The method of any one of the preceding embodiments, wherein the search technique for generating the set of hyperparameter configurations is an iterative deepening space search algorithm.
10. The method of any one of the preceding embodiments, wherein each hyperparameter configuration in the set of hyperparameter configurations comprises: a maximum tree depth, a minimum child weight, a maximum tree breadth, an average bias of residuals at a node, and an amount of improvement in a loss function.
11. The method of any one of the preceding embodiments, wherein the machine learning model uses a stochastic gradient boosting algorithm.
12. One or more tangible, non-transitory, computer-readable media storing instructions that, when executed by a data processing apparatus, cause the data processing apparatus to perform operations comprising those of any of embodiments 1-11.
13. A system comprising one or more processors; and memory storing instructions that, when executed by the processors, cause the processors to effectuate operations comprising those of any of embodiments 1-11.
14. A system comprising means for performing any of embodiments 1-11.

What is claimed is:

1. A system for performing model selection using hyperparameter optimization in conjunction with feature selection, comprising:
one or more processors; and
one or more non-transitory, computer-readable media storing instructions that, when executed by the one or more processors, cause operations comprising:
receiving training data intended for generating a final machine learning model, wherein the final machine learning model, once generated, includes a selection from a plurality of input features based on the training data and uses a first hyperparameter configuration;
training a preliminary machine learning model using the training data to generate learned parameter values of the preliminary machine learning model, wherein the preliminary machine learning model includes an entirety of the plurality of input features, and wherein the learned parameter values comprise feature values and node-level statistics of a gradient-boosted algorithm;
based on the learned parameter values of the preliminary machine learning model, defining a hyperparameter search space, wherein the hyperparameter search space comprises ranges for a set of hyperparameters for the final machine learning model;
generating a set of hyperparameter configurations from the hyperparameter search space;
generating, for each hyperparameter configuration in the set of hyperparameter configurations, a feature vector by executing a feature selection method, thereby generating a set of feature vectors corresponding to the set of hyperparameter configurations;
based on the set of feature vectors and the training data, generating a set of candidate models corresponding to the set of hyperparameter configurations, wherein each candidate model in the set of candidate models uses a feature vector in the set of feature vectors as input features and is trained using a hyperparameter configuration corresponding to the feature vector;
ranking the set of candidate models based on a performance metric; and
based on the rankings of the set of candidate models, selecting the final machine learning model from the set of candidate models.

2. A method for performing model selection using hyperparameter optimization in conjunction with feature selection, comprising:
receiving training data intended for generating a machine learning model, wherein the machine learning model, once generated, includes a selection from a plurality of input features based on the training data and uses a first hyperparameter configuration;
based on learned parameter values of a preliminary machine learning model trained using the training data, defining a hyperparameter search space,
wherein the preliminary machine learning model includes an entirety of the plurality of input features,
wherein the hyperparameter search space comprises ranges for a set of hyperparameters for the machine learning model;
based on a search technique, generating a set of hyperparameter configurations from the hyperparameter search space;
generating, for each hyperparameter configuration in the set of hyperparameter configurations, a feature vector by executing a feature selection method, thereby generating a set of feature vectors corresponding to the set of hyperparameter configurations;
based on the set of feature vectors and the training data, generating a set of candidate models corresponding to the set of hyperparameter configurations, wherein each candidate model in the set of candidate models uses a feature vector in the set of feature vectors as input features and is trained using a hyperparameter configuration corresponding to the feature vector;
ranking the set of candidate models based on a performance metric; and
based on the rankings of the set of candidate models, selecting the machine learning model from the set of candidate models.

3. The method of claim 2, wherein the search technique for generating the set of hyperparameter configurations is a Latin Hypercube sampling algorithm.

4. The method of claim 2, wherein the machine learning model uses a boosted gradient ensemble algorithm.

5. The method of claim 2, wherein the feature selection method for a hyperparameter configuration comprises:
initializing a standard feature set to train a prototype machine learning model with, wherein the prototype machine learning model uses an algorithm as the machine learning model and is trained on the training data, and wherein the prototype machine learning model uses the hyperparameter configuration for its hyperparameter values;
processing the prototype machine learning model to extract a feature importance vector, wherein the feature importance vector specifies an importance of each feature in the standard feature set in generating outputs of the prototype machine learning model; and
eliminating a set number of features from the standard feature set based on the feature importance vector.

6. The method of claim 2, wherein generating a candidate model in the set of candidate models from a feature vector in the set of feature vectors comprises:
performing a random permutation on the feature vector to generate a training feature set; and
training the candidate model using the training data, wherein the candidate model uses the training feature set as input features.

7. The method of claim 2, wherein ranking the set of candidate models based on the performance metric comprises:
partitioning the training data into a sample set and a testing set;
training each candidate model in the set of candidate models on the sample set;
for each candidate model in the set of candidate models, performing cross-validation testing of the candidate model using the testing set to obtain a performance metric; and
ranking the set of candidate models based on respective performance metrics.

8. The method of claim 2, wherein generating the machine learning model using the rankings of the set of candidate models comprises:
based on the rankings of the set of candidate models, generating a feature allocation map, wherein the feature allocation map correlates each candidate model in the set of candidate models with an integer number of features;
for each candidate model in the set of candidate models, use a feature ranking technique to extract a number of features equal to that specified by the feature allocation map; and
generating the machine learning model to use the extracted features as input.

9. The method of claim 2, wherein the search technique for generating the set of hyperparameter configurations is an iterative deepening space search algorithm.

10. The method of claim 2, wherein each hyperparameter configuration in the set of hyperparameter configurations comprises: a maximum tree depth, a minimum child weight, a maximum tree breadth, an average bias of residuals at a node, and an amount of improvement in a loss function.

11. The method of claim 2, wherein the machine learning model uses a stochastic gradient boosting algorithm.

12. One or more non-transitory computer-readable media comprising instructions that, when executed by one or more processors, cause operations comprising:
receiving training data intended for generating a machine learning model, wherein the machine learning model, once generated, includes a selection from a plurality of input features based on the training data and uses a first hyperparameter configuration;
based on learned parameter values of a preliminary machine learning model trained using the training data, defining a hyperparameter search space, wherein the hyperparameter search space comprises ranges for a set of hyperparameters for the machine learning model;
based on a search technique, generating a set of hyperparameter configurations from the hyperparameter search space;
generating, for each hyperparameter configuration in the set of hyperparameter configurations, a feature vector by executing a feature selection method, thereby generating a set of feature vectors corresponding to the set of hyperparameter configurations;
based on the set of feature vectors and the training data, generating a set of candidate models corresponding to the set of hyperparameter configurations, wherein each candidate model in the set of candidate models uses a feature vector in the set of feature vectors as input features; and
based on the set of candidate models and a performance metric, generating the machine learning model.

13. The one or more non-transitory computer-readable media of claim 12, wherein the search technique for generating the set of hyperparameter configurations is a Latin Hypercube sampling algorithm.

14. The one or more non-transitory computer-readable media of claim 12, wherein the machine learning model uses a boosted gradient ensemble algorithm.

15. The one or more non-transitory computer-readable media of claim 12, wherein the feature selection method for a hyperparameter configuration comprises:
initializing a standard feature set to train a prototype machine learning model with, wherein the prototype machine learning model uses an algorithm as the machine learning model and is trained on the training data, and wherein the prototype machine learning model uses the hyperparameter configuration for its hyperparameter values;
processing the prototype machine learning model to extract a feature importance vector, wherein the feature importance vector specifies an importance of each feature in the standard feature set in generating outputs of the prototype machine learning model; and
eliminating a set number of features from the standard feature set based on the feature importance vector.

16. The one or more non-transitory computer-readable media of claim 12, wherein generating a candidate model in the set of candidate models from a feature vector in the set of feature vectors comprises:
performing a random permutation on the feature vector to generate a training feature set; and
training the candidate model using the training data, wherein the candidate model uses the training feature set as input features.

17. The one or more non-transitory computer-readable media of claim 12, wherein the operation further comprise ranking the set of candidate models based on the performance metric, comprising:
partitioning the training data into a sample set and a testing set;
training each candidate model in the set of candidate models on the sample set;
for each candidate model in the set of candidate models, performing cross-validation testing of the candidate model using the testing set to obtain a performance metric; and
ranking the set of candidate models based on respective performance metrics.

18. The one or more non-transitory computer-readable media of claim 17, wherein generating the machine learning model using the set of candidate models comprises:
based on the rankings of the set of candidate models, generating a feature allocation map, wherein the feature allocation map correlates each candidate model in the set of candidate models with an integer number of features;
for each candidate model in the set of candidate models, use a feature ranking technique to extract a number of features equal to that specified by the feature allocation map; and
generating the machine learning model to use the extracted features as input.

19. The one or more non-transitory computer-readable media of claim 12, wherein the search technique for generating the set of hyperparameter configurations is an iterative deepening space search algorithm.

20. The one or more non-transitory computer-readable media of claim 12, wherein each hyperparameter configuration in the set of hyperparameter configurations comprises: a maximum tree depth, a minimum child weight, a maximum tree breadth, an average bias of residuals at a node, and an amount of improvement in a loss function.
